(19) United States
(12) Patent Application Publication
(10) Pub. No.: US 2017/0351452 A1
(43) Pub. Date: Dec. 7, 2017

(54) DYNAMIC HOST MEMORY BUFFER ALLOCATION

(71) Applicant: INTEL CORPORATION, Santa Clara, CA (US)

(72) Inventors: James A. BOYD, Hillsboro, OR (US); John W. CARROLL, Gilbert, AZ (US); Sanjeev N. TRIKA, Portland, OR (US)

(21) Appl. No.: 15/170,879

(22) Filed: Jun. 1, 2016

(51) Int. Cl. G06F 3/06

(52) U.S. Cl. CPC G06F 3/0631; G06F 3/0679; G06F 3/0611; G06F 3/0656

(57) ABSTRACT

In one embodiment, dynamic host memory buffer allocation in accordance with the present description includes sensing a level of activity of a memory or storage and dynamically allocating a portion of a host memory as a buffer to the non-volatile memory, as a function of a sensed level of activity of the non-volatile memory. Such dynamic allocation of host memory buffers as a function of sensed levels of activity, can improve the efficiency of the allocation of memory resources and improve system performance. Other aspects are described herein.

### TECHNICAL FIELD

Certain embodiments of the present description relate generally to management of memory resources.

### BACKGROUND

In contrast to volatile memory, non-volatile memory can store data that persists even after the power is removed from the non-volatile memory. However, the input/output performance of non-volatile memory is frequently slower than that of volatile memory such as a dynamic random access memory (DRAM) host memory. Accordingly, a portion of the faster host memory is frequently allocated to the slower non-volatile memory for use as a buffer.

### BRIEF DESCRIPTION OF THE DRAWINGS

Embodiments of the present disclosure are illustrated by way of example, and not by way of limitation, in the figures of the accompanying drawings in which like reference numerals refer to similar elements.

FIG. 1 depicts a high-level block diagram illustrating one embodiment of a system employing dynamic host memory buffer allocation in accordance with the present description.

FIG. 2 depicts a basic architecture of a memory employing dynamic host memory buffer allocation in accordance with the present description.

FIG. 3 depicts another embodiment of memories employing dynamic host memory buffer allocation in accordance with the present description.

FIGS. 4a-4c are schematic representations of examples of host memory buffers being dynamically allocated in accordance with one example of dynamic host memory buffer allocation in accordance with the present description.

FIG. 5 is an example of a table data structure stored in a host memory buffer of FIGS. 4a-4c.

FIGS. 6a, 6b depict examples of operations of dynamic host memory buffer allocation control logic in accordance with the present description.

### DESCRIPTION OF EMBODIMENTS

In the description that follows, like components have been given the same reference numerals, regardless of whether they are shown in different embodiments. To illustrate one or more embodiments of the present disclosure in a clear and concise manner, the drawings may not necessarily be to scale and certain features may be shown in somewhat schematic form. Features that are described or illustrated with respect to one embodiment may be used in the same way or in a similar way in one or more other embodiments or in combination with or instead of features of other embodiments.

In various computer architectures and data transfer protocols, such as Non-Volatile Memory Express (NVMe), for example, a portion of a host memory may be allocated to storage such as a solid state drive, to permit the associated storage to use the allocated portion of host memory in connection with storage operations. A host memory such as a dynamic random-access memory (DRAM) or nonvolatile random access memory (NVRAM) host memory, for example, is typically capable of performing input/output operations more quickly than non-volatile storage such as disk drives, or even solid state storage drives. Accordingly, a portion of the host memory may be allocated to a storage drive for use as a buffer to cache data which can then be accessed more quickly than data stored in the storage itself.

One example of the use of such a host memory buffer is to cache portions of an indirection look-up table such as a logical-to-physical (L2P) table mapping logical addresses to physical address of the associated storage. Such a table may be used for wear-leveling purposes, for example. More specifically, non-volatile solid state memory bitcells may wear out after a certain number of access operations such as write operations to the same bitcells. Accordingly, non-volatile solid state memory frequently incorporates wear leveling logic which employs algorithms to occasionally redirect selected write operations from one physical location to another to more evenly distribute those write operations across bitcells. As a result, write operations determined to be directed too frequently to the same physical location may be redirected using an L2P table to a different physical location to prevent or defer wearing out the bitcells at any one particular physical address.

Accordingly, allocating a portion of the host memory for use as a buffer by a solid state drive, allows the solid state drive to write-through cache its indirection L2P look-up table in the allocated portion of the host memory. In known systems, a particular portion of the host memory is allocated to a solid state drive before input/output operations to the solid state drive begin, and typically remains fixed in size as the system operates. Thus, the buffer size allocated to each solid state drive or other memory device remains unchanged in size in the host memory.

However, it is appreciated herein that the various solid state drives or other storage or memory devices of a system are commonly used for different purposes and at different times. For example, a boot drive may perform the majority of its input/output operations in the first few minutes of operation while the system boots itself, or once memory paging is initiated. Conversely, another drive storing application programs and data would typically perform the majority of its input/output operations after the system boot operations are complete.

It is further appreciated that in system implementations in which an L2P-cache is stored for a solid state drive in a host memory buffer allocated to the solid state drive, the performance of the solid state drive may depend significantly upon the size of the host memory buffer allocated to that solid state drive. Because the allocation is static in known systems, it is recognized herein that the fixed size of the host memory buffer may become too small for the solid state drive as the level of input/output activity rises for the solid state drive. As a result, performance of the solid state drive may be adversely affected by being allocated a host memory buffer which is too small for its current workload.

Conversely it is further recognized herein that the fixed size of the host memory buffer in known systems may become too large for the solid state drive as the level of input/output activity falls for the solid state drive. As a result, host memory resources may be poorly utilized for a solid state drive that does not need them while the performance levels of more active solid state drives suffer due to insufficient buffer resources allocated to the more active drives.

In one aspect of the present description, dynamic host memory buffer allocation is employed in a system of one or more computers configured to perform particular operations or actions of dynamic host memory buffer allocation by virtue of having software, firmware, hardware, or a combination of them installed on the system that in operation causes or cause the system to perform the actions. One or more computer programs can be configured to perform particular operations or actions of dynamic host memory buffer allocation by virtue of including instructions that, when executed by data processing apparatus, cause the apparatus to perform the actions.

One general aspect of dynamic host memory buffer allocation in accordance with the present description includes sensing a level of activity of a non-volatile memory, and dynamically allocating a portion of a host memory as a buffer to the non-volatile memory, as a function of a sensed level of activity of the non-volatile memory. For example, as activity directed to one non-volatile memory increases relative to another non-volatile memory, portions of host memory previously allocated to the non-volatile memory having decreasing activity, may be dynamically re-allocated to the non-volatile memory having increased activity. As explained in greater detail below, such dynamic allocation of host memory buffers as a function of sensed levels of activity, can improve the efficiency of the allocation of memory resources and improve system performance. Other embodiments of this aspect include corresponding computer systems, methods, apparatus, and computer programs recorded on one or more computer storage devices, each configured to perform dynamic host memory buffer allocation in accordance with the present description.

As used herein, the term dynamic includes operations performed in parallel with ongoing input/output operations to the associated memory. Accordingly, a host memory buffer allocation may be re-allocated while the associated memory is in use. As such the re-allocation may be performed for a particular memory without stopping input/output operations to the associated memory. Furthermore, the re-allocation may be performed for a particular memory without disrupting normal operation of the system or the associated memory. Thus, the re-allocation may be performed without rebooting the system, for example.

Implementations may further include one or more of the following features. In one aspect, allocations of portions of a host memory as buffers, may be dynamically re-balanced as a function of sensed respective levels of activity of the associated non-volatile memories. In one embodiment, re-balancing allocations includes shifting an allocation of a portion of a host memory from a one non-volatile memory to a second non-volatile memory as a function a sensed level of activity of the second non-volatile memory being greater than a sensed level of activity of the first non-volatile memory.

In another feature, a range of addresses of a host memory buffer allocated to one non-volatile memory, may be identified as storing inactive data. Further, a range of addresses of a host memory buffer identified as storing inactive data, may be shifted from a host memory buffer for one non-volatile memory to a host memory buffer for another non-volatile memory. As used herein, the term “inactive” data refers to data which is invalid or has been superseded by more current data. Accordingly, active data includes data which is not inactive, that is, data which is valid and has not been superseded by more current data.

In one embodiment, a host memory buffer for an associated solid state drive may store a portion of a logical-to-physical (L2P) address look-up table data structure for the associated solid state drive. For example, a logical-to-physical address look-up table data structure for an associated solid state drive may have logical-to-physical address mapping entries cached in the host memory buffer associated with the solid state drive. In one aspect, sensing respective levels of activity of various non-volatile memories may include sensing proportionate rates of unsuccessful attempts, such as cache misses, to look-up logical-to-physical address mapping entries of the logical-to-physical address look-up table data structures for the associated solid state drives. Accordingly, re-balancing allocations may include re-balancing allocations of portions of a host memory buffer to solid state drives as a function of sensed proportionate rates of unsuccessful attempts to look-up logical-to-physical address mapping entries found to be missing from the host memory buffer for associated solid state drives. Although described in connection with caching portions of an indirection look-up table such as a logical-to-physical (L2P) table mapping logical addresses to physical address of the associated storage, it is appreciated that dynamic host memory buffer allocation in accordance with the present description may be used in connection with other uses of a host memory buffer.

In another embodiment, the sensing respective levels of activity of various non-volatile memories may include sensing proportionate shares of quantities of read operations directed to the non-volatile memories. Accordingly, re-balancing allocations may include re-balancing allocations of portions of a host memory buffer as a function of sensed proportionate shares of quantities of read operations directed to the plurality of non-volatile memories.

In still another embodiment, sensing respective levels of activity of a plurality of non-volatile memories may include sensing proportionate shares of quantities of unique logical block addresses of read operations directed to the plurality of non-volatile memories. Accordingly, re-balancing allocations may include re-balancing allocations of portions of a host memory buffer as a function of sensed proportionate shares of quantities of unique logical block addresses of read operations directed to the plurality of non-volatile memories.

Implementations of the described techniques may include hardware, a method or process, or computer software on a computer-accessible medium.

It is appreciated that dynamic host memory buffer allocation in accordance with the present description may be applied to a variety of host, storage and other memory devices such as for example, memory devices that use chalcogenide phase change material (e.g., chalcogenide glass), three-dimensional (3D) crosspoint memory, or memory that incorporates memristor technology. Additional memory devices which may benefit from dynamic host memory buffer allocation in accordance with the present description may include other types of byte-addressable, write-in-place non-volatile memory, ferroelectric transistor random-access memory (FeTRAIVI), nanowire-based non-volatile memory, Magnetoresistive random-access memory (MRAM), Spin Transfer Torque (STT)-MRAM, Phase Change Memory (PCM), storage class memory (SCM), universal memory, Ge2Sb2Te5, programmable metallization cell (PMC), resistive memory (RRAM), RESET (amorphous) cell, SET (crystalline) cell, PCME, Ovshinsky memory, ferroelectric memory (also known as polymer memory and poly(N-vinylcarbazole)), ferromagnetic memory (also known as Spintronics, SPRAM (spin-transfer torque RAM)), STRAM (spin tunneling RAM), magnetic memory, magnetic random access memory (MRAM), and Semiconductor-oxide-nitride-oxidesemiconductor (SONOS, also known as dielectric memory). It is appreciated that other types of memory may benefit from dynamic host memory buffer allocation in accordance with the present description, depending upon the particular application.

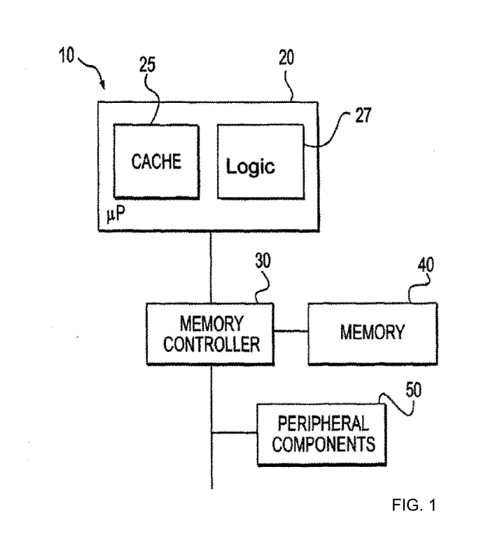

Turning to the figures, FIG. 1 is a high-level block diagram illustrating selected aspects of a computing system implemented according to an embodiment of the present disclosure. System 10 may represent any of a number of electronic or other computing devices, that may include a memory device. Such electronic devices may include computing devices such as a mainframe, server, personal computer, workstation, telephony device, network appliance, virtualization device, storage controller, portable or mobile devices (e.g., laptops, netbooks, tablet computers, personal digital assistant (PDAs), portable media players, portable gaming devices, digital cameras, mobile phones, smartphones, feature phones, etc.) or component (e.g. system on a chip, processor, bridge, memory controller, memory, etc.). System 10 can be powered by a battery, renewable power source (e.g., solar panel), wireless charging, or by use of an AC outlet.

In alternative embodiments, system 10 may include more elements, fewer elements, and/or different elements. Moreover, although system 10 may be depicted as comprising separate elements, it will be appreciated that such elements may be integrated on to one platform, such as systems on a chip (SoCs). In the illustrative example, system 10 comprises a microprocessor 20, a memory controller 30, a memory 40 and peripheral components 50 which may include, for example, video controller, input device, output device, storage, network adapter, a power source (including a battery, renewable power source (e.g., photovoltaic panel), wireless charging, or coupling to an AC outlet), etc. The microprocessor 20 includes a cache 25 that may be part of a memory hierarchy to store instructions and data, and the system memory 40 may also be part of the memory hierarchy. Communication between the microprocessor 20 and the memory 40 may be facilitated by the memory controller (or chipset) 30, which may also facilitate in communicating with the peripheral components 50.

Storage of the peripheral components 50 may be, for example, non-volatile storage, such as solid-state drives (SSD), magnetic disk drives, optical disk drives, a tape drive, flash memory, etc. The storage may comprise an internal storage device or an attached or network accessible storage. The microprocessor 20 is configured to write data in and read data from the memory 40. Programs in the storage are loaded into the memory and executed by the processor. A network controller or adapter enables communication with a network, such as an Ethernet, a Fiber Channel Arbitrated Loop, etc. Further, the architecture may, in certain embodiments, include a video controller configured to display information represented by data in a memory on a display monitor, where the video controller may be embodied on a video card or integrated on integrated circuit components mounted on a motherboard or other substrate. An input device is used to provide user input to the processor, and may include a keyboard, mouse, pen-stylus, microphone, touch sensitive display screen, input pins, sockets, or any other activation or input mechanism known in the art. An output device is capable of rendering information transmitted from the processor, or other component, such as a display monitor, printer, storage, output pins, sockets, etc. The network adapter may embodied on a network card, such as a Peripheral Component Interconnect (PCI) card, PCI-express, or some other I/O card, or on integrated circuit components mounted on a motherboard or other substrate.

One or more of the components of the device 10 may be omitted, depending upon the particular application. For example, a network router may lack a video controller, for example.

Any one or more of the memory devices 25, 40, and the other devices 10, 30, 50 may include a memory employing dynamic host memory buffer allocation in accordance with the present description, or be embodied as any type of data storage capable of storing data in a persistent manner (even if power is interrupted to non-volatile memory) such as but not limited to any combination of memory devices that use for example, chalcogenide phase change material (e.g., chalcogenide glass), three-dimensional (3D) crosspoint memory, or other types of byte-addressable, write-in-place non-volatile memory, ferroelectric transistor random-access memory (FeTRAM), nanowire-based non-volatile memory, phase change memory (PCM), memory that incorporates memristor technology, Magnetoresistive random-access memory (MRAM) or another Spin Transfer Torque (STT)-MRAM as described above. Such memory elements in accordance with embodiments described herein can be used either in stand-alone memory circuits or logic arrays, or can be embedded in microprocessors and/or digital signal processors (DSPs). Additionally, it is noted that although systems and processes are described herein primarily with reference to microprocessor based systems in the illustrative examples, it will be appreciated that in view of the disclosure herein, certain aspects, architectures, and principles of the disclosure are equally applicable to other types of device memory and logic devices.

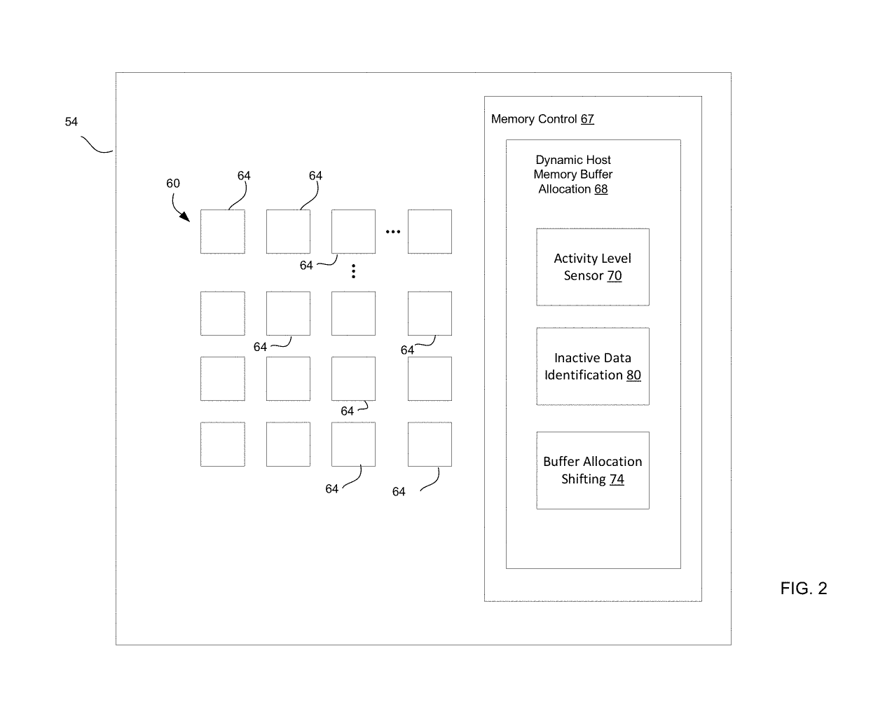

FIG. 2 shows an example of a memory 54 which may be employed as a host memory or storage employing dynamic host memory buffer allocation in accordance with the present description. The memory 54 has a rectangular or orthogonal array 60 of rows and columns of cells such as the bitcells 64, in which each bitcell 64 is configured to store a bit state.

The memory 54 may also include a row decoder, a timer device and I/O devices (or I/O outputs). Bits of the same memory word may be separated from each other for efficient I/O design. A multiplexer (MUX) may be used to connect each column to the required circuitry during a READ operation. Another MUX may be used to connect each column to a write driver during a WRITE operation. A memory control circuit 67 such as a memory controller is configured to control and perform read and write operations directed to the bitcells 64 as explained below. The memory control circuit 67 is configured to perform the described operations using appropriate hardware, software or firmware, or various combinations thereof. As explained in greater detail below, the memory control circuit 67 includes dynamic host memory buffer allocation control logic 68 having an activity level sensor 70 configured to sense a level of activity of a non-volatile memory. The dynamic host memory buffer allocation logic 68 is configured to be responsive to the activity level sensor 70 and to dynamically allocate a portion of a host memory as a host memory buffer for the non-volatile memory as a function of a sensed level of activity of the non-volatile memory. An implementation of the host memory buffer allocation control logic 68 which includes software, may include host storage or memory drivers and controllers, for example.

In one embodiment, the dynamic host memory buffer allocation logic 68 further includes allocation shifting logic 74 configured to shift an allocation of a portion of a host memory from one non-volatile memory to another non-volatile memory as a function a sensed level of activity of the latter non-volatile memory being greater than the sensed level of activity of the former non-volatile memory. In this manner allocations of portions of the host memory to host memory buffers associated with the non-volatile memories may be re-balanced as a function of sensed respective levels of activity of the non-volatile memories.

In another aspect, the dynamic host memory buffer allocation logic 68 further includes inactive data identification logic 80 configured to identify a range of addresses of a host memory buffer which is storing inactive data. Accordingly, the allocation shifting logic 74 is configured to shift a range of addresses of a host memory identified as storing inactive data, from the host memory buffer containing the identified inactive data to a different, more active host memory buffer.

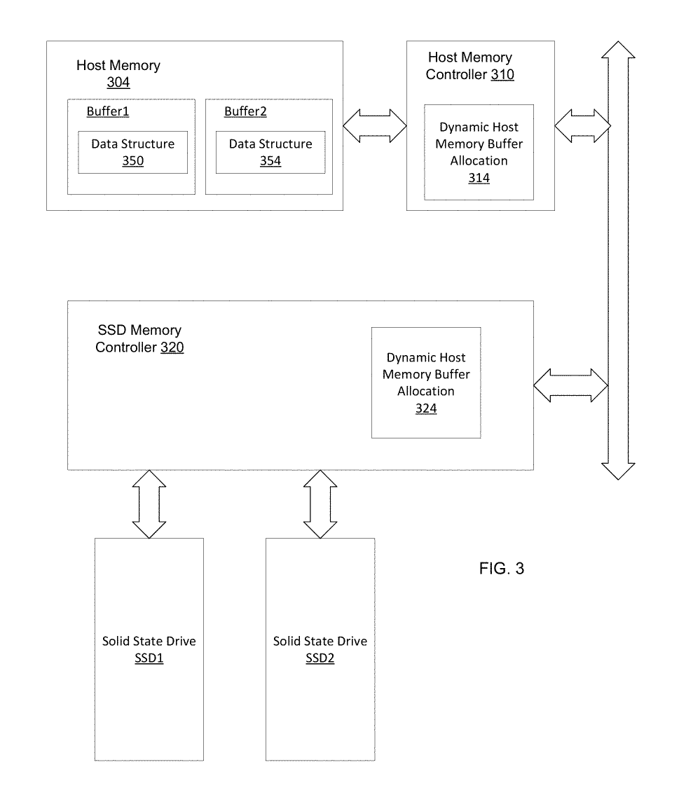

FIG. 3 shows another example of a memory, a host memory 304 in this example, having a host memory controller 310 employing dynamic host memory buffer allocation control logic 314 in accordance with the present description. The host memory 304 may be part of the memory 40 (FIG. 1), for example.

FIG. 3 shows yet another example of a memory, a pair of storage devices, solid state drive SSD1, solid state drive SSD2, in this example, having a solid state drive (SSD) memory controller 320 employing dynamic host memory buffer allocation control logic 324 in accordance with the present description. The storage devices, solid state drive SSD1, solid state drive SSD2, may be part of the devices 50 (FIG. 1), for example. It is appreciated that a memory controller such as the memory controllers 67 (FIG. 2), 310 (FIG. 3), 320 may be considered as logically a part of the associated memory as depicted in FIG. 2, or may be considered as logically separate from the associated memory as represented in FIG. 3. The actual physical layout of the controllers, bitcell arrays and associated circuitry may vary, depending upon the particular application.

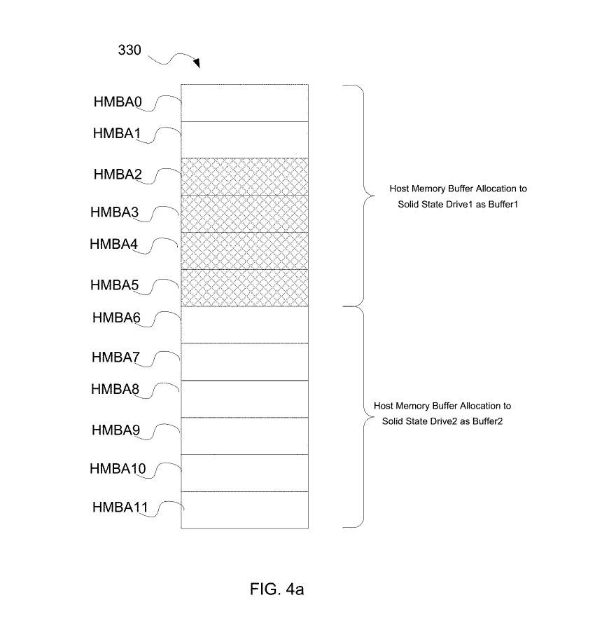

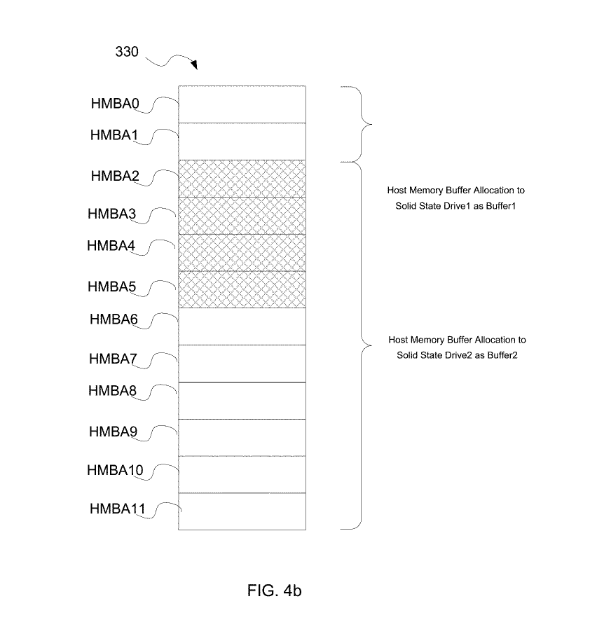

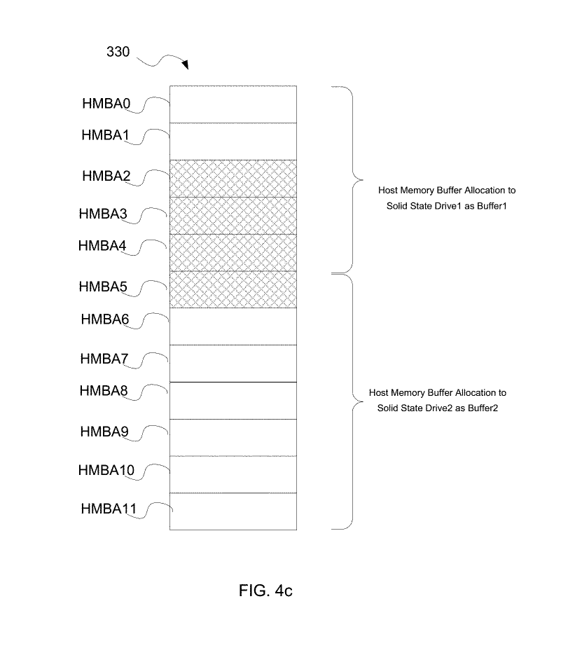

In the example of FIG. 3 a portion of the host memory 304, represented by a host memory block address range 330 (FIG. 4a) which in this example includes host memory block addresses HMBA0-HMBA11, is allocated to the two storage drives, SSD1, SSD2 (FIG. 3), respectively, as host memory buffers, buffer1 and buffer2, respectively. Thus, the host memory 304 is configured to store a host memory buffer for each non-volatile memory, SSD1, SSD2. Although described in connection with two memories SSD1, SSD2, each having an associated host memory buffer, Buffer1, Buffer2, respectively, in the illustrated embodiment, it is appreciated that host memory buffer allocation in accordance with the present description may be applied to a fewer or greater number of memories and associated buffer memories, depending upon the particular application.

In this example, FIG. 4a represents the initial allocations of the host memory to the two storage drives, SSD1, SSD2 (FIG. 3). In this initial allocation, the host memory block address range 330 is split evenly between the two storage drives, SSD1, SSD2 (FIG. 3). Accordingly, Buffer1 for the storage drive SSD1 is allocated six memory locations HMBA0-HMBA5 and Buffer2 for the storage drive SSD2, is allocated six memory locations HMBA6-HMBA11 as shown in FIG. 4a. It is anticipated that in many applications, the block address range 300 may have thousands, millions, billions or more memory locations. However, for purposes of clarity, FIG. 4a depicts twelve such representative memory locations, each having a host memory physical block address HMBA0, HMBA1, HMBA11 in this example. In one embodiment, each memory location HMBA0, HMBA1, HMBA11, has sufficient bitcells to store tens, hundreds, or a thousand or more bytes of data, depending upon the particular application.

In the illustrated embodiment, each host memory buffer, Buffer1, Buffer2, is configured to cache a portion of a logical-to-physical (L2P) indirection look-up table in the form of a data structure 350, 354 (FIG. 3). FIG. 5 shows an example of an entry 504 of an L2P indirection look-up table. In this example, the L2P indirection look-up table entry 504 is cached in the data structure 350 (FIG. 3) of the host member buffer, Buffer1, allocated to the solid state drive SSD1. More specifically, the L2P indirection look-up table entry 504 is cached in the host memory block address HBMA1 as indicated in FIG. 5. The host memory block address HBMA1 is within the range of addresses allocated to the solid state drive SSD1 for its host memory buffer, Buffer1.

Each entry of the L2P indirection look-up table includes a logical address field 510 which stores a logical block address which has been mapped to a physical block address stored in a physical address field 514 of the entry. In the example of FIG. 5, the logical block address LBA8 has been mapped to the physical block address PBA5 as indicated by the entry 504 of the L2P indirection look-up table represented in FIG. 5. Accordingly, an input or output operation directed to the logical block address LBA8 is directed to the physical block address PBA5 of the solid state drive SSD1 by the entry 504 of the L2P indirection look-up table represented in FIG. 5.

As set forth above, the L2P indirection look-up table entry 504 is cached in the host memory block address HBMA1 of the host memory buffer, Buffer1, assigned to the solid state drive SSD1. Hence, an attempt to read the logical to physical address mapping for logical block address LBA8 in the cache memory of the host memory buffer, Buffer1, would be successful, since the L2P indirection look-up table entry 504 is cached in the host memory block address HBMA1 of the host memory buffer, Buffer1. As such, the successful attempt to read the logical to physical address mapping for logical block address LBA8 in the cache memory of the host memory buffer, Buffer1, would be treated as a cache “hit.”

Conversely, if the L2P indirection look-up table entry for a different logical block address was not cached in the cache memory of the host memory buffer, Buffer1, an attempt to read the logical to physical address mapping for the latter logical block address would not be successful, since the L2P indirection look-up table entry for the latter logical block address was not cached in the host memory buffer, Buffer1. As such, the unsuccessful attempt to read the logical to physical address mapping for the latter logical block address in the cache memory of the host memory buffer, Buffer1, would be treated as a cache “miss.” As described in greater detail below, such cache hits and misses may be employed in dynamic host memory buffer allocation in accordance with one embodiment of the present description. For example, an excessive number of cache misses may be indicative that the current host memory buffer allocation for the solid state drive SSD1 is too small, given the current level of activity directed to the solid state drive SSD1.

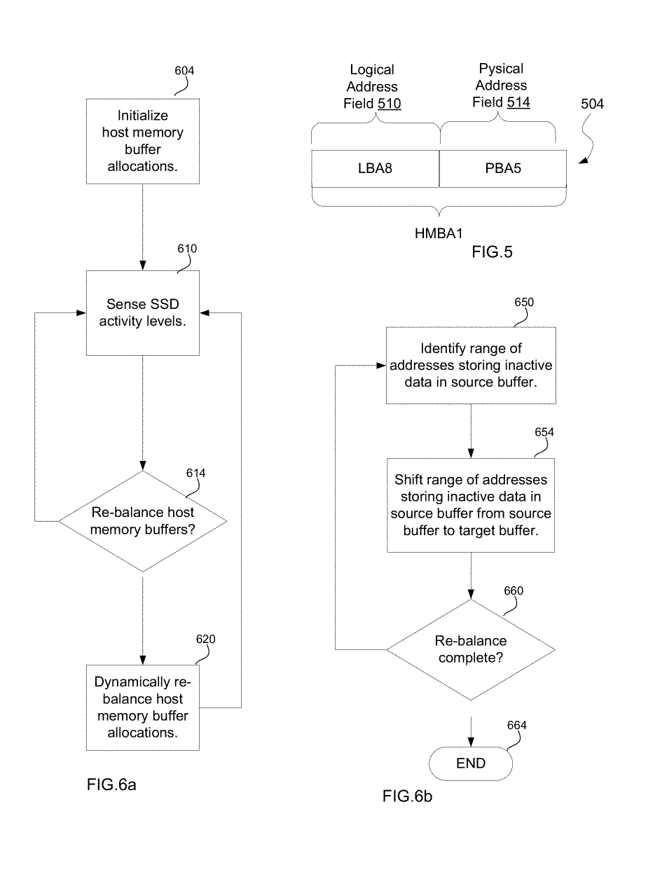

FIGS. 6a and 6b depict examples of operations of dynamic host memory buffer allocation in accordance with the present description. In one operation, the host memory buffer allocations are initialized (block 604) for each memory such as the solid state drives SSD1, SSD2 (FIG. 3), which are each to be allocated a portion of the host memory 304 for use as a buffer. The operations depicted in FIGS. 6a, 6b may be performed by logic of one or more of the dynamic host memory buffer allocation control logic 314, 324. Thus, logic performing the operations depicted in FIGS. 6a, 6b may be located in a host memory controller 310 (FIG. 3), for example, or in a storage controller such as the SSD memory controller 320, or both, depending upon the particular application. It is appreciated that dynamic host memory buffer allocation control logic in accordance with the present description may be located in other portions of a computer system, depending upon the particular application.

In the example of FIG. 4a, the range 330 of host memory block addresses HMBA0-HMBA11 are initially allocated to the host memory buffers, Buffer1, Buffer2, in such a manner so as to be split evenly between the buffers, Buffer1, Buffer2 as shown in FIG. 4a. As a result, the buffers, Buffer1, Buffer2 are initialized as equal in size in the example of FIG. 4a, prior to subsequent re-balancing operations discussed below. It is appreciated however, that the initial sizes of the host memory buffers may have other relative sizes, depending upon the particular application.

The host memory buffers, Buffer1, Buffer2 are associated with the solid state drives SSD1, SSD2, respectively in this example. As input/output operations directed to the solid state drives SSD1, SSD2 proceed, an activity level sensor such as the activity level sensor 70 (FIG. 2) is configured to sense (block 610, FIG. 6a) respective levels of activity of the solid state drives SSD1, SSD2.

In the embodiment of FIG. 3, one or more of the dynamic host memory buffer allocation control logic 314, 324, in a manner similar to that of the dynamic host memory buffer allocation control logic 68 (FIG. 3), may have an activity level sensor similar to the activity level sensor 70 (FIG. 3), and configured to sense a level of activity of a non-volatile memory. As explained below, in the embodiment of FIG. 3, at least one of a dynamic host memory buffer allocation logic 314, 324 is configured to be responsive to an activity level sensor and to dynamically allocate a portion of a host memory as a host memory buffer for the non-volatile memory as a function of a sensed level of activity of the non-volatile memory. An implementation of the host memory buffer allocation control logic 314, 324 which includes software, may include host storage drivers and controllers, for example.

In one embodiment, an activity level sensor of one or both of memory buffer allocation control logic 314, 324 may be configured to sense (block 610, FIG. 6a) proportionate shares of quantities of read operations directed to the various non-volatile memories having host memory buffers allocated to them. For example, the activity level sensor can sense the ratio of the number of detected read operations directed to the host memory buffer, Buffer1, with respect to the number of detected read operations directed to the other host memory buffer, Buffer2. Accordingly, as described below, re-balancing allocations may include re-balancing allocations of portions of a host memory buffer as a function of the ratios of sensed quantities of read operations directed to the various non-volatile memories.

In another embodiment, an activity level sensor of one or both of memory buffer allocation control logic 314, 324 may be configured to sense (block 610, FIG. 6a) respective levels of activity of a plurality of non-volatile memories, may include sensing proportionate rates of unsuccessful attempts, such as cache misses, to look-up logical-to-physical address mapping entries missing from the logical-to-physical address look-up table data structures cached in the host memory buffers for the associated solid state drives. For example, the activity level sensor can sense the ratio of the number of detected cache misses for read operations directed to the host memory buffer, Buffer1, with respect to the number of detected cache misses for read operations directed to the other host memory buffer, Buffer2. Accordingly, one or both of dynamic memory buffer allocation control logic 314, 324 may be configured to re-balance allocations of buffers within a host memory for solid state drives as a function of the ratios of sensed rates of unsuccessful attempts to look-up logical-to-physical address mapping entries found to be missing from the host memory buffer for associated solid state drives. Thus, in one embodiment, the greater the proportionate share of cache misses, the greater the subsequent re-allocation of host memory buffer space to that memory, to reduce cache misses.

In still another embodiment, an activity level sensor of one or both of memory buffer allocation control logic 314, 324 may be configured to sense (block 610, FIG. 6a) respective levels of activity of a plurality of non-volatile memories by sensing proportionate shares of quantities of unique logical block addresses of read operations directed to the plurality of non-volatile memories. For example, the activity level sensor can sense the ratio of the number of detected unique logical block addresses of read operations directed to the host memory buffer, Buffer1, with respect to the number of detected unique logical block addresses of read operations directed to the other host memory buffer, Buffer2. Accordingly, one or both of dynamic memory buffer allocation control logic 314, 324 may be configured to re-balance allocations of buffers within a host memory as a function of sensed proportionate shares or ratios of quantities of unique logical block addresses of read operations directed to the plurality of non-volatile memories.

As a function of sensed respective levels of activity of the different non-volatile memories, one or both of dynamic memory buffer allocation control logic 314, 324 may be configured to determine (block 614, FIG. 6a) whether to re-balance the host memory buffer allocations. Such a determination may be made in a variety of techniques, depending upon the particular application. For example, if the initial allocation (block 604) of the host memory is an evenly distributed subdivision of the host memory buffer area such that the host memory buffers, Buffer1, Buffer2, for example, are initialized as equal in size as shown in the example of FIG. 4a, for example, and yet the sensed (block 610, FIG. 6a) activity levels of the host memory buffers, Buffer1, Buffer2 are not equal, a dynamic re-balancing (block 620) of the host memory buffer allocations may be appropriate. In another example, if the sensed level of usage of a particular host memory buffer falls below a certain threshold, it may be determined (block 614, FIG. 6a) to re-balance (block 620) the host memory buffer allocations.

Such a dynamic host memory buffer allocation re-balancing may be performed as a function of sensed respective levels of activity of the different non-volatile memories as described above. For example, if the current sensed (block 610, FIG. 6a) activity levels of the host memory buffers, Buffer1, Buffer2 are in a ratio of 1 to 5, such that the current sensed level of activity of the Buffer2 is five times that of the Buffer1, the dynamic host memory buffer allocation may be re-balanced such that the Buffer2 is reallocated a portion of the host memory which is five times the size of the portion of the host memory reallocated to the Buffer1, for example, as shown in FIG. 4b, for example. Thus, in the example of FIG. 4b, as a result of the host memory buffer allocation rebalancing (620, FIG. 6a), the host memory buffer, Buffer1, is allocated host memory block addresses HMBA0-HMBA1 (FIG. 4b), and the host memory buffer, Buffer2, is allocated five times the host memory block addresses, that is, host memory block addresses HMBA2-HMBA11, for example.

In another example, if the current sensed (block 610, FIG. 6a) activity levels of the host memory buffers, Buffer1, Buffer2 change again, such that they are determined to be in a ratio of 5 to 7, for example, such that the current sensed level of activity of the Buffer2 is 7/5 or 1.4 times that of the Buffer1, the dynamic host memory buffer allocation may be re-balanced such that the Buffer2 is reallocated a portion of the host memory which is reduced to 1.4 times the size of the portion of the host memory reallocated to the Buffer1, for example, as shown in FIG. 4c, for example. Thus, in the example of FIG. 4c, as a result of the host memory buffer allocation rebalancing (620, FIG. 6a), the host memory buffer, Buffer1, is allocated host memory block addresses HMBA0-HMBA4 (FIG. 4c), and the host memory buffer, Buffer2, is allocated five times the host memory block addresses, that is, host memory block addresses HMBA5-HMBA11, for example. It is appreciated that the degree of host memory buffer allocation re-balancing which is undertaken in response to changes in comparative sensed activity levels may vary, depending upon the particular application.

In one embodiment, the activity level sensing (block 610) may be periodically activated to sense respective activity levels. Thus after a certain period of time, T, host memory buffer devices may be polled, by host software such as a driver using an appropriate command such as a “Get Features” command, for example, in an NVMe embodiment, to determine the current configuration or levels of activity associated with each device. Accordingly, host memory buffer allocations may be periodically re-balanced (blocks 614, 620) as needed if respective levels of the activity of the memories shift over time. As a result, the host memory buffer allocations may be shifted as well as many times as needed, allowing the system to utilize the allocated memory resources in a more efficient manner.

It is noted that in previous NVMe architectures, the size and location of a host memory buffer was not modified using commands of the existing command set while the host memory feature was enabled as a feature of the NVMe architecture. Thus, in one embodiment of host memory buffer allocation in accordance with the present description, commands of the existing command set of the NVMe architecture such as the “Get Features” command may be utilized to determine (block 610) the current configuration or level of activity associated with each memory device. Similarly, commands of the existing command set of the NVMe architecture such as the “Set Features” command, may be utilized to re-balance (blocks 614, 620) the host memory buffer allocations for the memory devices by disabling the host memory buffer feature and then re-enabling the host memory buffer feature so that the host memory buffers have appropriately resized host memory allocations.

In another embodiment of host memory buffer allocation in accordance with the present description, the NVMe architecture command set may be modified by adding a new feature identifier. For example, a new feature identifier may be selected from an appropriate vendor specific range such as the range C0h-FFh of feature identifiers, for example. The associated memory device, such as the solid state drive SSD1 (FIG. 3) and its associated driver may be configured to recognize the selected new feature identifier.

Using the new feature identifier, a host may send various types of new Set Feature commands to achieve an appropriate re-balancing (blocks 614, 620) of the host memory buffer allocations without disabling the host memory buffer feature. For example, using a selected new feature identifier, a Set Feature command may be sent to add host memory buffer space to the allocation for a particular host memory buffer such as Buffer2 (FIG. 3), for example, for a particular storage drive such solid state drive SSD2, without first disabling the host memory buffer feature. Conversely, using a selected new feature identifier, another new Set Feature command may be sent to subtract (in whole or in part) host memory buffer space from the allocation for a host memory buffer such as host memory buffer Buffer1 for a particular storage drive such as solid state drive SSD1, for example, without disabling the host memory buffer feature.

Accordingly, instead of enabling and disabling a host memory buffer feature using commands of the existing command set of the NVMe architecture, new Set Feature commands such as those described above may be added to the Set Feature command set of the NVMe architecture using a selected new feature identifier. The new Set Feature commands may be used to add and remove portions of the host memory allocated to storage drives for use as host memory buffers, without disabling the buffers and disrupting ongoing input/output operations to the host memory buffers.

In one embodiment, to increase the size of host memory allocated to a buffer for a particular memory device, the host may send a new version of a Set Features command, referred to herein as an “add new allocation” Set Features command, to provide a new buffer and thus additional buffer space to the allocation for a particular memory device. Conversely, to decrease the size of the host memory allocated to a buffer for a particular memory device, the host may send another new version of a Set Features command, referred to herein as a “remove existing allocation” Set Features command to remove a buffer in whole or in part from the buffer space allocation for a particular memory device. Should all host memory buffers be removed from the host memory, the host memory buffer feature is effectively disabled. To check the current configuration of a host memory buffer without modifying the buffer, the host may send a new version of a Get Features command using a selected new feature identifier.

FIG. 6b depicts one example of re-balancing operations of dynamic host memory buffer allocation in accordance with the present description. The re-balancing operations of FIG. 6b are initiated if it is determined (block 614, FIG. 6a), based upon sensed levels of memory activity, to re-balance (block 620) the host memory buffer allocations. In an NVMe embodiment, for example, host software such as a driver using a “Set Features” command modified as described above, may be utilized to initiate a re-balancing of allocations of host memory buffer space from one buffer to another.

In the example of FIG. 6a, one buffer, referred to herein as a source buffer, may be experiencing a decline in activity level. Alternatively, another buffer, referred to herein as a target buffer, may be experiencing an increase in activity level, or both may be occurring at the same time. In each of these scenarios, the activity level of the source buffer is considered to be declining relative to that of the target buffer and the activity level of the target buffer is considered to be increasing relative to that of the source buffer. Thus, where the activity level of the source buffer is considered to be declining relative to that of the target buffer (or the activity level of the target buffer is considered to be increasing relative to that of the source buffer), an allocation of host memory buffer space may be transferred from the source buffer to the target buffer to re-balance the buffer allocations in accordance with the sensed levels of activity of the buffers.

In one embodiment, to re-balance the host memory buffer allocations from a source buffer to a target buffer having increased activity relative to the source buffer, a range of addresses within the source buffer which are storing inactive data, may be identified (block 650). In one embodiment, one or more of the dynamic host memory buffer allocation control logic 314, 324 further includes inactive data identification logic similar to the inactive data identification logic 80 (FIG. 3), and configured to identify (block 650, FIG. 6b) a range of addresses of a host memory buffer which is storing inactive data.

For example, in FIG. 4a, four host memory block addresses HMBA2-HMBA5 of the host memory block addresses HMBA0-HMBA5 allocated to the host memory buffer Buffer1, have been identified (block 650, FIG. 6a) as storing inactive data which may be invalid data or stale data which has been superseded by more current data stored elsewhere. The four host memory block addresses HMBA2-HMBA5 identified (block 650, FIG. 6a) as storing inactive data are indicated as such in FIG. 4a with cross-hatching. Conversely, the remaining host memory block addresses HMA0-HMA1 allocated to the host memory buffer, Buffer1, lack such cross-hatching in FIG. 4a and thus are identified as storing active data which is valid data not superseded by more current data elsewhere.

One or more of the dynamic host memory buffer allocation control logic 314, 324, further includes allocation shifting logic similar to the allocation shift logic 74 (FIG. 3), and configured to shift (block 654) a portion of an allocation of buffer space of a source buffer of a host memory, from the source buffer to another buffer, that is, the target buffer, as a function the respective sensed levels of activity of the non-volatile memories. Accordingly, the allocation shifting logic is configured to shift a range of addresses of a source buffer identified as storing inactive data, from the source buffer containing the identified inactive data to a different, more active host memory buffer, that is the target buffer.

FIG. 4b depicts an example of the host memory block addresses HMBA2-HMBA5 identified (block 650, FIG. 6a) as storing inactive data, having been shifted (block 654, FIG. 6a) from the allocation of FIG. 4a for the source host memory buffer, Buffer1, to the allocation for the target host memory buffer, Buffer2. Alternatively, FIG. 4c depicts an example of only some of the host memory block addresses HMBA2-HMBA5 identified (block 650, FIG. 6a) as storing inactive data, that is, host memory block address HMBA5 as having been shifted (block 654, FIG. 6a) from the allocation of FIG. 4a for the source host memory buffer, Buffer1, to the allocation for the target host memory buffer, Buffer2. Accordingly, in the example of FIG. 4c, the remaining host memory block addresses HMBA2-HMBA4 of the host memory block addresses HMBA2-HMBA5 identified (block 650, FIG. 6a) as storing inactive data, remain with the source host memory buffer, Buffer1, following the shifting of the host memory block address HMBA 5 from the allocation for the source host memory buffer, Buffer1, to the allocation for the target host memory buffer, Buffer2.

Although the shifting of addresses from a source buffer to a target buffer is described herein in connection with buffer space identified as containing inactive data, it is appreciated that in some embodiments, dynamic host memory buffer allocation in accordance with the present description may also include shifting buffer space containing active data from a source buffer to a target buffer. In such embodiments, the active data may transferred to another location within the source buffer, or may be flushed (transferred) from the source buffer to the associated storage before the re-allocation takes place, to preserve the active data before it is overwritten as a part of the target host memory buffer.

One or more of the dynamic host memory buffer allocation control logic 314, 324, is further configured to determine (block 660, FIG. 6b) whether the re-balancing is complete (block 664). As noted above, in one embodiment, dynamic host memory buffer allocation re-balancing may be performed as a function of sensed respective levels of activity of the different non-volatile memories. Thus, in one embodiment, the re-balancing may be determined to be complete once sufficient addresses have been shifted such that the ratios of the respective sizes of the host memory buffers match or substantially match the sensed ratios of the respective levels of activity of the host memory buffers as described above. Hence, if for example, the ratio of the sensed activity levels of the host memory buffers, Buffer1, Buffer2, were determined to be 1 to 5, the rebalancing may be determined to be complete once sufficient addresses have been shifted such that the ratios of the respective sizes of the host memory buffers is 1 to 5 as shown in FIG. 4b, for example, matching the sensed ratio of the respectively levels of activity.

Alternatively, in another embodiment, the re-balancing may be determined to be complete once sufficient addresses have been shifted such that the ratios of the respective sizes of the host memory buffers are closer to the sensed ratios of the respective levels of activity of the host memory buffers as described above, but need not match. Thus, the rebalancing may be determined to be complete once sufficient addresses have been shifted such that the ratios of the respective sizes of the host memory buffers is 5 to 7 as depicted in FIG. 4c, for example wherein the ratio of 5 to 7 is closer to the ratio of sensed activity level of 1 to 5 as compared to an initial size allocation of 1 to 1 as shown in FIG. 4a, for example. It is appreciated that various criterion may be utilized to determine when re-balancing as a function of sensed levels of activity, is complete, depending upon the particular application. In this manner allocations of portions of the host memory to host memory buffers associated with the non-volatile memories may be re-balanced as a function of sensed respective levels of activity of the non-volatile memories.

Dynamic host memory buffer allocation in accordance with the present description may also be applied to events such as a storage drive failing or powered down. If so, the level of activity for such a failed or non-operational storage drive may be sensed as having fallen to zero. Accordingly, the dynamic host memory buffer allocation logic can dynamically re-allocate the host memory buffer space previously allocated to the failed or inoperative drive, to one or more active drives.

Although described in connection with shifting a portion of a buffer allocation from one host memory buffer to another host memory buffer, it is appreciated that dynamic host memory buffer allocation in accordance with the present description may be achieved by reducing or increasing the size of a particular host memory buffer for a particular memory or storage without affecting the sizes of other host memory buffers. Further, it is appreciated that dynamic host memory buffer allocation in accordance with the present description may be achieved by reducing or increasing the size of a particular host memory buffer without affecting the sizes of other host memory buffers to the same extent.

### Examples

The following examples pertain to further embodiments.

Example 1 is an apparatus for use with a host memory configured to store a host memory buffer for an associated non-volatile memory, the apparatus comprising: dynamic host memory buffer allocation logic having an activity level sensor configured to sense a level of activity of a non-volatile memory, wherein the dynamic host memory buffer allocation logic is configured to be responsive to the activity level sensor and to dynamically allocate a portion of a host memory as a host memory buffer for the non-volatile memory as a function of a sensed level of activity of the non-volatile memory.

In Example 2, the subject matter of Examples 1-9 (excluding the present Example), can optionally include a plurality of non-volatile memories, each non-volatile memory having a portion of the host memory allocated to the associated non-volatile memory as a host memory buffer for the associated non-volatile memory, wherein the activity level sensor is configured to sense respective levels of activity of the plurality of non-volatile memories, and wherein the dynamic host memory buffer allocation logic is further configured to re-balance allocations of portions of the host memory to host memory buffers as a function of sensed respective levels of activity of the plurality of non-volatile memories.

In Example 3, the subject matter of Examples 1-9 (excluding the present Example), can optionally include wherein the plurality of non-volatile memories includes first and second non-volatile memories, the activity level sensor is configured to sense first and second levels of activity of first and second non-volatile memories, and the dynamic host memory buffer allocation logic includes allocation shifting logic configured to shift an allocation of a portion of a host memory from the first non-volatile memory to the second non-volatile memory as a function the sensed second level of activity of the second non-volatile memory being greater than the sensed first level of activity of the first non-volatile memory, to re-balance allocations of portions of the host memory to host memory buffers associated with the first and second non-volatile memories as a function of sensed respective levels of activity of the first and second non-volatile memories.

In Example 4, the subject matter of Examples 1-9 (excluding the present Example), can optionally include wherein the dynamic host memory buffer allocation logic further includes inactive data identification logic configured to identify a range of addresses of a host memory buffer allocated to the first non-volatile memory, which are storing inactive data, and wherein the allocation shifting logic is configured to shift a range of addresses of a host memory identified as storing inactive data, from a host memory buffer of the first non-volatile memory to a host memory buffer of the second non-volatile memory.

In Example 5, the subject matter of Examples 1-9 (excluding the present Example), can optionally include wherein each non-volatile memory is a solid state drive and wherein a portion of a host memory allocated to an associated solid state drive stores at least a portion of a logical-to-physical address look-up table data structure for an associated solid state drive.

In Example 6, the subject matter of Examples 1-9 (excluding the present Example), can optionally include wherein a logical-to-physical address look-up table data structure for an associated solid state drive has logical-to-physical address mapping entries, the activity level sensor is further configured to sense proportionate rates of unsuccessful attempts to look-logical-to-physical address mapping entries missing from logical-to-physical address look-up table data structures for associated solid state drives, and wherein the re-balancing allocations includes re-balancing allocations of portions of a host memory buffer to solid state drives as a function of sensed proportionate rates of unsuccessful attempts to look-up logical-to-physical address mapping entries missing from logical-to-physical address look-up table data structures for associated solid state drives.

In Example 7, the subject matter of Examples 1-9 (excluding the present Example), can optionally include wherein the activity level sensor is further configured to sense proportionate shares of quantities of read operations directed to the plurality of non-volatile memories, and wherein the dynamic host memory buffer allocation logic is further configured to re-balance allocations of portions of a host memory buffer as a function of sensed proportionate shares of quantities of read operations directed to the plurality of non-volatile memories.

In Example 8, the subject matter of Examples 1-9 (excluding the present Example), can optionally include wherein the activity level sensor is further configured to sense proportionate shares of quantities of unique logical block addresses of read operations directed to the plurality of non-volatile memories, and wherein the dynamic host memory buffer allocation logic is further configured to re-balance allocations of portions of a host memory buffer as a function of sensed proportionate shares of quantities of unique logical block addresses of read operations directed to the plurality of non-volatile memories.

In Example 9, the subject matter of Examples 1-9 (excluding the present Example), can optionally include a computing system, comprising: a non-volatile memory, a host memory configured to store a host memory buffer associated with the non-volatile memory, a processor configured to cause a data write into and a data read from the non-volatile memory and the host memory, and any of: a display communicatively coupled to the processor, a network interface communicatively coupled to the processor, or a battery coupled to provide power to the system.

Example 10 is a method, comprising: sensing a level of activity of a non-volatile memory, and dynamically allocating a portion of a host memory as a buffer for the non-volatile memory as a function of a sensed level of activity of the non-volatile memory.

In Example 11, the subject matter of Examples 10-17 (excluding the present Example), can optionally include wherein the sensing a level of activity of a non-volatile memory includes sensing respective levels of activity of a plurality of non-volatile memories, and wherein the dynamically allocating includes re-balancing allocations of portions of a host memory as a buffer as a function of sensed respective levels of activity of the plurality of non-volatile memories.

In Example 12, the subject matter of Examples 10-17 (excluding the present Example), can optionally include wherein the sensing respective levels of activity of a plurality of non-volatile memories includes sensing first and second levels of activity of first and second non-volatile memories, and wherein the re-balancing allocations includes shifting an allocation of a portion of a host memory from the first non-volatile memory to the second non-volatile memory as a function the sensed second level of activity of the second non-volatile memory being greater than the sensed first level of activity of the first non-volatile memory.

In Example 13, the subject matter of Examples 10-17 (excluding the present Example), can optionally include identifying a range of addresses of a host memory buffer allocated to the first non-volatile memory, which are storing inactive data, wherein the shifting an allocation of a portion of a host memory from a host memory buffer for first non-volatile memory to a host memory buffer for the second non-volatile memory, includes shifting a range of addresses of a host memory identified as storing inactive data, from a host memory buffer for the first non-volatile memory to a host memory buffer for the second non-volatile memory.

In Example 14, the subject matter of Examples 10-17 (excluding the present Example), can optionally include wherein each non-volatile memory is a solid state drive and wherein a host memory buffer for an associated solid state drive stores a logical-to-physical address look-up table data structure for the associated solid state drive.

In Example 15, the subject matter of Examples 10-17 (excluding the present Example), can optionally include wherein a logical-to-physical address look-up table data structure for an associated solid state drive has logical-to-physical address mapping entries, the sensing respective levels of activity of a plurality of non-volatile memories includes sensing proportionate rates of unsuccessful attempts to look-up logical-to-physical address mapping entries missing from logical-to-physical address look-up table data structures for associated solid state drives, and wherein the re-balancing allocations includes re-balancing allocations of portions of a host memory buffer to solid state drives as a function of sensed proportionate rates of unsuccessful attempts to look-up logical-to-physical address mapping entries missing from logical-to-physical address look-up table data structures for associated solid state drives.

In Example 16, the subject matter of Examples 10-17 (excluding the present Example), can optionally include wherein the sensing respective levels of activity of a plurality of non-volatile memories includes sensing proportionate shares of quantities of read operations directed to the plurality of non-volatile memories, and wherein the re-balancing allocations includes re-balancing allocations of portions of a host memory buffer as a function of sensed proportionate shares of quantities of read operations directed to the plurality of non-volatile memories.

In Example 17, the subject matter of Examples 10-17 (excluding the present Example), can optionally include wherein the sensing respective levels of activity of a plurality of non-volatile memories includes sensing proportionate shares of quantities of unique logical block addresses of read operations directed to the plurality of non-volatile memories, and wherein the re-balancing allocations includes re-balancing allocations of portions of a host memory buffer as a function of sensed proportionate shares of quantities of unique logical block addresses of read operations directed to the plurality of non-volatile memories.

Example 18 is an apparatus for memory comprising means to perform a method as claimed in any preceding claim.”

Example 19 is a computing system, comprising: a non-volatile memory, a host memory configured to store a host memory buffer associated with the non-volatile memory, a processor configured to cause a data write into and a data read from the non-volatile memory and the host memory, and dynamic host memory buffer allocation logic having an activity level sensor configured to sense a level of activity of a non-volatile memory, wherein the dynamic host memory buffer allocation logic is configured to be responsive to the activity level sensor and to dynamically allocate a portion of a host memory as a host memory buffer for the non-volatile memory as a function of a sensed level of activity of the non-volatile memory.

In Example 20, the subject matter of Examples 19-27 (excluding the present Example), can optionally include a plurality of non-volatile memories, each non-volatile memory having a portion of the host memory allocated to the associated non-volatile memory as a host memory buffer for the associated non-volatile memory, wherein the activity level sensor is configured to sense respective levels of activity of the plurality of non-volatile memories, and wherein the dynamic host memory buffer allocation logic is further configured to re-balance allocations of portions of the host memory to host memory buffers as a function of sensed respective levels of activity of the plurality of non-volatile memories.

In Example 21, the subject matter of Examples 19-27 (excluding the present Example), can optionally include wherein the plurality of non-volatile memories includes first and second non-volatile memories, the activity level sensor is configured to sense first and second levels of activity of first and second non-volatile memories, and the dynamic host memory buffer allocation logic includes allocation shifting logic configured to shift an allocation of a portion of a host memory from the first non-volatile memory to the second non-volatile memory as a function the sensed second level of activity of the second non-volatile memory being greater than the sensed first level of activity of the first non-volatile memory, to re-balance allocations of portions of the host memory to host memory buffers associated with the first and second non-volatile memories as a function of sensed respective levels of activity of the first and second non-volatile memories.

In Example 22, the subject matter of Examples 19-27 (excluding the present Example), can optionally include wherein the dynamic host memory buffer allocation logic further inactive data identification logic configured to identify a range of addresses of a host memory buffer allocated to the first non-volatile memory, which are storing inactive data, and wherein the allocation shifting logic is configured to shift a range of addresses of a host memory identified as storing inactive data, from a host memory buffer of the first non-volatile memory to a host memory buffer of the second non-volatile memory.

In Example 23, the subject matter of Examples 19-27 (excluding the present Example), can optionally include wherein each non-volatile memory is a solid state drive and wherein a portion of a host memory allocated to an associated solid state drive stores at least a portion of a logical-to-physical address look-up table data structure for an associated solid state drive.

In Example 24, the subject matter of Examples 19-27 (excluding the present Example), can optionally include wherein a logical-to-physical address look-up table data structure for an associated solid state drive has logical-to-physical address mapping entries, the activity level sensor is further configured to sense proportionate rates of unsuccessful attempts to look-logical-to-physical address mapping entries missing from logical-to-physical address look-up table data structures for associated solid state drives, and wherein the re-balancing allocations includes re-balancing allocations of portions of a host memory buffer to solid state drives as a function of sensed proportionate rates of unsuccessful attempts to look-up logical-to-physical address mapping entries missing from logical-to-physical address look-up table data structures for associated solid state drives.

In Example 25, the subject matter of Examples 19-27 (excluding the present Example), can optionally include wherein the activity level sensor is further configured to sense proportionate shares of quantities of read operations directed to the plurality of non-volatile memories, and wherein the dynamic host memory buffer allocation logic is further configured to re-balance allocations of portions of a host memory buffer as a function of sensed proportionate shares of quantities of read operations directed to the plurality of non-volatile memories.

In Example 26, the subject matter of Examples 19-27 (excluding the present Example), can optionally include wherein the activity level sensor is further configured to sense proportionate shares of quantities of unique logical block addresses of read operations directed to the plurality of non-volatile memories, and wherein the dynamic host memory buffer allocation logic is further configured to re-balance allocations of portions of a host memory buffer as a function of sensed proportionate shares of quantities of unique logical block addresses of read operations directed to the plurality of non-volatile memories.

In Example 27, the subject matter of Examples 19-27 (excluding the present Example), can optionally include any of: a display communicatively coupled to the processor, a network interface communicatively coupled to the processor, or a battery coupled to provide power to the system. Example 28 is an apparatus for use with a host memory configured to store a host memory buffer for an associated non-volatile memory, the apparatus comprising: dynamic host memory buffer allocation logic means having an activity level sensor means for sensing a level of activity of a non-volatile memory, wherein the dynamic host memory buffer allocation logic means is responsive to the activity level sensor means, for dynamically allocating a portion of a host memory as a host memory buffer for the non-volatile memory as a function of a sensed level of activity of the non-volatile memory.

In Example 29, the subject matter of Examples 28-36 (excluding the present Example), can optionally include a plurality of non-volatile memories, each non-volatile memory having a portion of the host memory allocated to the associated non-volatile memory as a host memory buffer for the associated non-volatile memory, wherein the activity level sensor means is configured for sensing respective levels of activity of the plurality of non-volatile memories, and wherein the dynamic host memory buffer allocation logic means is further configured for re-balancing allocations of portions of the host memory to host memory buffers as a function of sensed respective levels of activity of the plurality of non-volatile memories.

In Example 30, the subject matter of Examples 28-36 (excluding the present Example), can optionally include wherein the plurality of non-volatile memories includes first and second non-volatile memories, the activity level sensor means is configured for sensing first and second levels of activity of first and second non-volatile memories, and the dynamic host memory buffer allocation logic means includes allocation shifting logic means for shifting shift an allocation of a portion of a host memory from the first non-volatile memory to the second non-volatile memory as a function the sensed second level of activity of the second non-volatile memory being greater than the sensed first level of activity of the first non-volatile memory, to re-balance allocations of portions of the host memory to host memory buffers associated with the first and second non-volatile memories as a function of sensed respective levels of activity of the first and second non-volatile memories.

In Example 31, the subject matter of Examples 28-36 (excluding the present Example), can optionally include wherein the dynamic host memory buffer allocation logic means further includes inactive data identification logic means for identifying a range of addresses of a host memory buffer allocated to the first non-volatile memory, which are storing inactive data, and wherein the allocation shifting logic means is configured for shifting a range of addresses of a host memory identified as storing inactive data, from a host memory buffer of the first non-volatile memory to a host memory buffer of the second non-volatile memory.

In Example 32, the subject matter of Examples 28-36 (excluding the present Example), can optionally include wherein each non-volatile memory is a solid state drive and wherein a portion of a host memory allocated to an associated solid state drive stores at least a portion of a logical-to-physical address look-up table data structure for an associated solid state drive.

In Example 33, the subject matter of Examples 28-36 (excluding the present Example), can optionally include wherein a logical-to-physical address look-up table data structure for an associated solid state drive has logical-to-physical address mapping entries, the activity level sensor means is further configured for sensing proportionate rates of unsuccessful attempts to look-logical-to-physical address mapping entries missing from logical-to-physical address look-up table data structures for associated solid state drives, and wherein the re-balancing allocations includes re-balancing allocations of portions of a host memory buffer to solid state drives as a function of sensed proportionate rates of unsuccessful attempts to look-up logical-to-physical address mapping entries missing from logical-to-physical address look-up table data structures for associated solid state drives.

In Example 34, the subject matter of Examples 28-36 (excluding the present Example), can optionally include wherein the activity level sensor means is further configured to sense proportionate shares of quantities of read operations directed to the plurality of non-volatile memories, and wherein the dynamic host memory buffer allocation logic means is further configured for re-balancing allocations of portions of a host memory buffer as a function of sensed proportionate shares of quantities of read operations directed to the plurality of non-volatile memories.

In Example 35 the subject matter of Examples 28-36 (excluding the present Example), can optionally include wherein the activity level sensor means is further configured for sensing proportionate shares of quantities of unique logical block addresses of read operations directed to the plurality of non-volatile memories, and wherein the dynamic host memory buffer allocation logic means is further configured for re-balancing allocations of portions of a host memory buffer as a function of sensed proportionate shares of quantities of unique logical block addresses of read operations directed to the plurality of non-volatile memories.

In Example 36, the subject matter of Examples 28-36 (excluding the present Example), can optionally include a computing system, comprising: a non-volatile memory, a host memory means for storing to store a host memory buffer associated with the non-volatile memory, a processor means for causing a data write into and a data read from the non-volatile memory and the host memory means, and any of: a display communicatively coupled to the processor, a network interface communicatively coupled to the processor, or a battery coupled to provide power to the system.

Example 37 is a computer program product for a memory wherein the computer program product comprises a computer readable storage medium having program instructions embodied therewith, the program instructions executable by a processor to cause processor operations, the processor operations comprising: sensing a level of activity of a non-volatile memory; and dynamically allocating a portion of a host memory as a buffer for the non-volatile memory as a function of a sensed level of activity of the non-volatile memory.

In Example 38, the subject matter of Examples 37-44 (excluding the present Example), can optionally include wherein the sensing a level of activity of a non-volatile memory includes sensing respective levels of activity of a plurality of non-volatile memories, and wherein the dynamically allocating includes re-balancing allocations of portions of a host memory as a buffer as a function of sensed respective levels of activity of the plurality of non-volatile memories.

In Example 39, the subject matter of Examples 37-44 (excluding the present Example), can optionally include wherein the sensing respective levels of activity of a plurality of non-volatile memories includes sensing first and second levels of activity of first and second non-volatile memories, and wherein the re-balancing allocations includes shifting an allocation of a portion of a host memory from the first non-volatile memory to the second non-volatile memory as a function the sensed second level of activity of the second non-volatile memory being greater than the sensed first level of activity of the first non-volatile memory.

In Example 40, the subject matter of Examples 37-44 (excluding the present Example), can optionally include wherein the operations further comprise identifying a range of addresses of a host memory buffer allocated to the first non-volatile memory, which are storing inactive data, wherein the shifting an allocation of a portion of a host memory from a host memory buffer for first non-volatile memory to a host memory buffer for the second non-volatile memory, includes shifting a range of addresses of a host memory identified as storing inactive data, from a host memory buffer for the first non-volatile memory to a host memory buffer for the second non-volatile memory.

In Example 41, the subject matter of Examples 37-44 (excluding the present Example), can optionally include wherein each non-volatile memory is a solid state drive and wherein a host memory buffer for an associated solid state drive stores a logical-to-physical address look-up table data structure for the associated solid state drive.

In Example 42, the subject matter of Examples 37-44 (excluding the present Example), can optionally include wherein a logical-to-physical address look-up table data structure for an associated solid state drive has logical-to-physical address mapping entries, the sensing respective levels of activity of a plurality of non-volatile memories includes sensing proportionate rates of unsuccessful attempts to look-up logical-to-physical address mapping entries missing from logical-to-physical address look-up table data structures for associated solid state drives, and wherein the re-balancing allocations includes re-balancing allocations of portions of a host memory buffer to solid state drives as a function of sensed proportionate rates of unsuccessful attempts to look-up logical-to-physical address mapping entries missing from logical-to-physical address look-up table data structures for associated solid state drives.

In Example 43, the subject matter of Examples 37-44 (excluding the present Example), can optionally include wherein the sensing respective levels of activity of a plurality of non-volatile memories includes sensing proportionate shares of quantities of read operations directed to the plurality of non-volatile memories, and wherein the re-balancing allocations includes re-balancing allocations of portions of a host memory buffer as a function of sensed proportionate shares of quantities of read operations directed to the plurality of non-volatile memories.

In Example 44, the subject matter of Examples 37-44 (excluding the present Example), can optionally include wherein the sensing respective levels of activity of a plurality of non-volatile memories includes sensing proportionate shares of quantities of unique logical block addresses of read operations directed to the plurality of non-volatile memories, and wherein the re-balancing allocations includes re-balancing allocations of portions of a host memory buffer as a function of sensed proportionate shares of quantities of unique logical block addresses of read operations directed to the plurality of non-volatile memories.

The described operations may be implemented as a method, apparatus or computer program product using standard programming and/or engineering techniques to produce software, firmware, hardware, or any combination thereof. The described operations may be implemented as computer program code maintained in a “computer readable storage medium”, where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmissions signals. Those skilled in the art will recognize that many modifications may be made to this configuration without departing from the scope of the present description, and that the article of manufacture may comprise suitable information bearing medium known in the art. Of course, those skilled in the art will recognize that many modifications may be made to this configuration without departing from the scope of the present description, and that the article of manufacture may comprise any tangible information bearing medium known in the art.

In certain applications, a device in accordance with the present description, may be embodied in a computer system including a video controller to render information to display on a monitor or other display coupled to the computer system, a device driver and a network controller, such as a computer system comprising a desktop, workstation, server, mainframe, laptop, handheld computer, etc. Alternatively, the device embodiments may be embodied in a computing device that does not include, for example, a video controller, such as a switch, router, etc., or does not include a network controller, for example.

The illustrated logic of figures may show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to limit to the precise form disclosed. Many modifications and variations are possible in light of the above teaching.

What is claimed is:

1. An apparatus for use with a host memory configured to store a host memory buffer for an associated non-volatile memory, the apparatus comprising:
dynamic host memory buffer allocation logic having an activity level sensor configured to sense a level of activity of a non-volatile memory, wherein the dynamic host memory buffer allocation logic is configured to be responsive to the activity level sensor and to dynamically allocate a portion of a host memory as a host memory buffer for the non-volatile memory as a function of a sensed level of activity of the non-volatile memory.

2. The apparatus of claim 1 further comprising a plurality of non-volatile memories, each non-volatile memory having a portion of the host memory allocated to the associated non-volatile memory as a host memory buffer for the associated non-volatile memory, wherein the activity level sensor is configured to sense respective levels of activity of the plurality of non-volatile memories, and wherein the dynamic host memory buffer allocation logic is further configured to re-balance allocations of portions of the host memory to host memory buffers as a function of sensed respective levels of activity of the plurality of non-volatile memories.

3. The apparatus of claim 2 wherein the plurality of non-volatile memories includes first and second non-volatile memories, the activity level sensor is configured to sense first and second levels of activity of first and second non-volatile memories, and the dynamic host memory buffer allocation logic includes allocation shifting logic configured to shift an allocation of a portion of a host memory from the first non-volatile memory to the second non-volatile memory as a function the sensed second level of activity of the second non-volatile memory being greater than the sensed first level of activity of the first non-volatile memory, to re-balance allocations of portions of the host memory to host memory buffers associated with the first and second non-volatile memories as a function of sensed respective levels of activity of the first and second non-volatile memories.

4. The apparatus of claim 3 wherein the dynamic host memory buffer allocation logic further includes inactive data identification logic configured to identify a range of addresses of a host memory buffer allocated to the first non-volatile memory, which are storing inactive data, and wherein the allocation shifting logic is configured to shift a range of addresses of a host memory identified as storing inactive data, from a host memory buffer of the first non-volatile memory to a host memory buffer of the second non-volatile memory.

5. The apparatus of claim 2 wherein each non-volatile memory is a solid state drive and wherein a portion of a host memory allocated to an associated solid state drive stores at least a portion of a logical-to-physical address look-up table data structure for an associated solid state drive.

6. The apparatus of claim 5 wherein a logical-to-physical address look-up table data structure for an associated solid state drive has logical-to-physical address mapping entries, the activity level sensor is further configured to sense proportionate rates of unsuccessful attempts to look-logical-to-physical address mapping entries missing from logical-to-physical address look-up table data structures for associated solid state drives, and wherein the re-balancing allocations includes re-balancing allocations of portions of a host memory buffer to solid state drives as a function of sensed proportionate rates of unsuccessful attempts to look-up logical-to-physical address mapping entries missing from logical-to-physical address look-up table data structures for associated solid state drives.

7. The apparatus of claim 2 wherein the activity level sensor is further configured to sense proportionate shares of quantities of read operations directed to the plurality of non-volatile memories, and wherein the dynamic host memory buffer allocation logic is further configured to re-balance allocations of portions of a host memory buffer as a function of sensed proportionate shares of quantities of read operations directed to the plurality of non-volatile memories.

8. The apparatus of claim 2 wherein the activity level sensor is further configured to sense proportionate shares of quantities of unique logical block addresses of read operations directed to the plurality of non-volatile memories, and wherein the dynamic host memory buffer allocation logic is further configured to re-balance allocations of portions of a host memory buffer as a function of sensed proportionate shares of quantities of unique logical block addresses of read operations directed to the plurality of non-volatile memories.

9. A method, comprising:
sensing a level of activity of a non-volatile memory; and
dynamically allocating a portion of a host memory as a buffer for the non-volatile memory as a function of a sensed level of activity of the non-volatile memory.

10. The method of claim 9 wherein the sensing a level of activity of a non-volatile memory includes sensing respective levels of activity of a plurality of non-volatile memories, and wherein the dynamically allocating includes re-balancing allocations of portions of a host memory as a buffer as a function of sensed respective levels of activity of the plurality of non-volatile memories.

11. The method of claim 10 wherein the sensing respective levels of activity of a plurality of non-volatile memories includes sensing first and second levels of activity of first and second non-volatile memories, and wherein the re-balancing allocations includes shifting an allocation of a portion of a host memory from the first non-volatile memory to the second non-volatile memory as a function the sensed second level of activity of the second non-volatile memory being greater than the sensed first level of activity of the first non-volatile memory.

12. The method of claim 11 further comprising identifying a range of addresses of a host memory buffer allocated to the first non-volatile memory, which are storing inactive data, wherein the shifting an allocation of a portion of a host memory from a host memory buffer for first non-volatile memory to a host memory buffer for the second non-volatile memory, includes shifting a range of addresses of a host memory identified as storing inactive data, from a host memory buffer for the first non-volatile memory to a host memory buffer for the second non-volatile memory.

13. The method of claim 10 wherein each non-volatile memory is a solid state drive and wherein a host memory buffer for an associated solid state drive stores a logical-to-physical address look-up table data structure for the associated solid state drive.

14. The method of claim 13 wherein a logical-to-physical address look-up table data structure for an associated solid state drive has logical-to-physical address mapping entries, the sensing respective levels of activity of a plurality of non-volatile memories includes sensing proportionate rates of unsuccessful attempts to look-up logical-to-physical address mapping entries missing from logical-to-physical address look-up table data structures for associated solid state drives, and wherein the re-balancing allocations includes re-balancing allocations of portions of a host memory buffer to solid state drives as a function of sensed proportionate rates of unsuccessful attempts to look-up logical-to-physical address mapping entries missing from logical-to-physical address look-up table data structures for associated solid state drives.

15. The method of claim 10 wherein the sensing respective levels of activity of a plurality of non-volatile memories includes sensing proportionate shares of quantities of read operations directed to the plurality of non-volatile memories, and wherein the re-balancing allocations includes re-balancing allocations of portions of a host memory buffer as a function of sensed proportionate shares of quantities of read operations directed to the plurality of non-volatile memories.

16. The method of claim 10 wherein the sensing respective levels of activity of a plurality of non-volatile memories includes sensing proportionate shares of quantities of unique logical block addresses of read operations directed to the plurality of non-volatile memories, and wherein the re-balancing allocations includes re-balancing allocations of portions of a host memory buffer as a function of sensed proportionate shares of quantities of unique logical block addresses of read operations directed to the plurality of non-volatile memories.

17. A computing system, comprising:
a non-volatile memory;
a host memory configured to store a host memory buffer associated with the non-volatile memory;
a processor configured to cause a data write into and a data read from the non-volatile memory and the host memory; and
dynamic host memory buffer allocation logic having an activity level sensor configured to sense a level of activity of a non-volatile memory, wherein the dynamic host memory buffer allocation logic is configured to be responsive to the activity level sensor and to dynamically allocate a portion of a host memory as a host memory buffer for the non-volatile memory as a function of a sensed level of activity of the non-volatile memory.

18. The system of claim 17 further comprising a plurality of non-volatile memories, each non-volatile memory having a portion of the host memory allocated to the associated non-volatile memory as a host memory buffer for the associated non-volatile memory, wherein the activity level sensor is configured to sense respective levels of activity of the plurality of non-volatile memories, and wherein the dynamic host memory buffer allocation logic is further configured to re-balance allocations of portions of the host memory to host memory buffers as a function of sensed respective levels of activity of the plurality of non-volatile memories.

19. The system of claim 18 wherein the plurality of non-volatile memories includes first and second non-volatile memories, the activity level sensor is configured to sense first and second levels of activity of first and second non-volatile memories, and the dynamic host memory buffer allocation logic includes allocation shifting logic configured to shift an allocation of a portion of a host memory from the first non-volatile memory to the second non-volatile memory as a function the sensed second level of activity of the second non-volatile memory being greater than the sensed first level of activity of the first non-volatile memory, to re-balance allocations of portions of the host memory to host memory buffers associated with the first and second non-volatile memories as a function of sensed respective levels of activity of the first and second non-volatile memories.

20. The system of claim 19 wherein the dynamic host memory buffer allocation logic further inactive data identification logic configured to identify a range of addresses of a host memory buffer allocated to the first non-volatile memory, which are storing inactive data, and wherein the allocation shifting logic is configured to shift a range of addresses of a host memory identified as storing inactive data, from a host memory buffer of the first non-volatile memory to a host memory buffer of the second non-volatile memory.

21. The system of claim 18 wherein each non-volatile memory is a solid state drive and wherein a portion of a host memory allocated to an associated solid state drive stores at least a portion of a logical-to-physical address look-up table data structure for an associated solid state drive.

22. The system of claim 21 wherein a logical-to-physical address look-up table data structure for an associated solid state drive has logical-to-physical address mapping entries, the activity level sensor is further configured to sense proportionate rates of unsuccessful attempts to look-logical-to-physical address mapping entries missing from logical-to-physical address look-up table data structures for associated solid state drives, and wherein the re-balancing allocations includes re-balancing allocations of portions of a host memory buffer to solid state drives as a function of sensed proportionate rates of unsuccessful attempts to look-up logical-to-physical address mapping entries missing from logical-to-physical address look-up table data structures for associated solid state drives.

23. The system of claim 18 wherein the activity level sensor is further configured to sense proportionate shares of quantities of read operations directed to the plurality of non-volatile memories, and wherein the dynamic host memory buffer allocation logic is further configured to re-balance allocations of portions of a host memory buffer as a function of sensed proportionate shares of quantities of read operations directed to the plurality of non-volatile memories.

24. The system of claim 18 wherein the activity level sensor is further configured to sense proportionate shares of quantities of unique logical block addresses of read operations directed to the plurality of non-volatile memories, and wherein the dynamic host memory buffer allocation logic is further configured to re-balance allocations of portions of a host memory buffer as a function of sensed proportionate shares of quantities of unique logical block addresses of read operations directed to the plurality of non-volatile memories.

25. The system of claim 17, further comprising any of:
a display communicatively coupled to the processor;
a network interface communicatively coupled to the processor; or
a battery coupled to provide power to the system.
